(19) United States
(12) Patent Application Publication
(10) Pub. No.: US 2015/0174832 A1
(43) Pub. Date: Jun. 25, 2015

(54) METHOD FOR THE AUTOMATED MANUFACTURING OF A SPATIAL STRUCTURE FROM FIBRE- REINFORCED PLASTIC, AND DEVICE FOR CARRYING OUT SUCH A METHOD

(71) Applicants: Apparatebau Gauting Gmbh, Gauting (DE); Technische Universität Dresden, Dresden (DE)

(72) Inventors: Ulrich Wollenweber, Schrobenhausen (DE); Marco Zichner, Dresden (DE); Florian Lenz, Dresden (DE); Werner Hufenbach, Dresden (DE); Bernd Grüber, Bischofswerda (DE)

(73) Assignees: TECHNISCHE UNIVERSITÄT DRESDEN, Dresden (DE); APPARATEBAU GAUTING GMBH, Gauting (DE)

(21) Appl. No.: 14/575,094

(22) Filed: Dec. 18, 2014

(30) Foreign Application Priority Data
Dec. 20, 2013 (DE) 102013021642.7

(51) Int. Cl. B29C 70/38; B29C 70/34; B29C 70/68

(52) U.S. Cl. CPC B29C 70/386; B29C 70/68; B29C 70/388; B29C 70/34; B29K 2105/0872

(57) ABSTRACT

Method for the automated manufacturing of a spatial structure from fibre-reinforced plastic, and device for carrying out such a method

The present invention relates in particular to methods for the automated manufacturing of a spatial structure from fibre-reinforced plastic, wherein the structure is constructed successively and in an automated manner from a multiplicity of individual fibre-texture blanks, in that the individual fibre-texture blanks are successively adjoined, and in that a plastic material which forms a matrix for the respective fibre-composite blank is consolidated in situ in a localized manner.

### BACKGROUND OF THE INVENTION

The present invention relates in particular to a method for the automated manufacturing of a spatial structure from fibre-reinforced plastic, and a device for carrying out such a method, or for manufacturing such a structure, respectively.

### DISCUSSION OF THE PRIOR ART

For manufacturing structures or bodies from fibre-reinforced plastics it is known, for example, to lay up planar semi-finished products from a fibre-reinforced plastic, for example a mandrel or a hollow body composed of two half-shells, on a negative mould, and to subject the negative mould with the plastic material laid thereupon to a curing step in which the fibre-reinforced plastic material which is on the negative mould is cured so as to correspond to the negative mould. However, this method is comparatively complex, cost-intensive and, besides, can only cover a limited variety of shapes.

It is furthermore known for pre-consolidated thermoplastic fibre tapes to be laid up on a negative mould and to tack-weld, i.e. to temporarily fasten, the tapes thereto by punctiform heating. In a further step, a structure generated in such a manner is heated and consolidated, i.e. cured and solidified, in a subsequent pressing process. Here, only a very limited variety of shapes can be covered; it is hardly possible for structures having undercuts to be manufactured, for example.

Moreover, structures from fibre-reinforced plastic materials may be manufactured using a method known as “tape welding”. In the case of tape welding, a pre-consolidated thermoplastic fibre tape is placed onto the negative mould by a laying head; at the same time, the tape is melted by means of a laser beam and, in order to be consolidated, pressed by the laying head. This method is highly cost-intensive and there is the risk of pores being formed in the laminate.

### SUMMARY OF THE INVENTION

It is an object of the invention to eliminate the disadvantages in the prior art. In particular, a method for the manufacturing of a spatial structure from fibre-reinforced plastic by way of which, in particular, a comparatively free selection of the orientation of fibres can be attained, which, in particular, can be carried out in a comparatively simple and cost-effective manner, which, in particular, has a comparatively wide range of application, and by way of which, in particular, nevertheless a comparatively high quality in the manufactured structures can be attained is to be provided.

The present invention is directed to a method for the automated manufacturing of a spatial structure. The spatial structure in particular may be a two-dimensional or three-dimensional body, or a structural component or a component, a supporting structure, a spatial body, in particular an open or substantially closed body having a volume which is surrounded by a wall, a shell structure, a spatial structure, in particular a planar and/or curved spatial structure, a component of a structure or a reinforcement structure. The reinforcement structure may be configured or manufactured, for example, on an already existing body, in particular a body manufactured from fibre-reinforced plastic. It is furthermore possible that two or more already existing bodies, in particular further spatial structures, are interconnected by way of the spatial structure manufactured from the fibre-crosslay blanks. The latter means that the spatial structure as per the method according to the invention may also be manufactured or provided in order to connect two or more part-structures or part-bodies, in particular such which already exist, to form a complete structure or a complete body.

Fibre-reinforced plastic here refers in particular to a material which comprises a fibre texture which has been impregnated with a plastic material. In particular, a fibre crosslay and/or a fibre fabric, a felt-type fibrous material and similar may be used as a fibre texture.

Corresponding to the proposed method, the structure, at least in part or in portions, is constructed successively and in an automated manner from a multiplicity of individual fibre-texture blanks or fibre-structure blanks, respectively, in that the individual fibre-texture blanks are deposited successively, in particular so as to be adjoining, at the respective target position, and in that a plastic material which forms a matrix for the in each case deposited fibre-composite blank is cured or consolidated, respectively, in a localized manner, i.e. in situ at the depository. Adjoining of the fibre-texture blanks here may take place in an overlapping and/or non-overlapping and/or abutting and/or at least in part abutting manner. In particular, the fibre-texture blanks may be adjoined so as to be peripherally overlapping, in particular in part peripherally overlapping, and/or so as to abut, in particular at least in part, in a peripheral or encircling manner, i.e. without substantial overlap. In particular in the case of an arrangement of the fibre-texture blanks which is conceived so as to at least in part abut, the spatial structure may be successively assembled and constructed in the manner of the construction of a mosaic. In the case of a non-overlapping arrangement which is to comprise an arrangement in which adjacent fibre-texture blanks are arranged in a staggered manner, and in the case of an at least in part abutting arrangement, gaps between adjacent fibre-texture blanks may be flooded or filled, respectively, or patched using the plastic material of the matrix during or in the context of consolidation, in particular such that a two-dimensionally compact structure without gaps is generated.

As per the method according to the invention, the spatial structure may be constructed from a multiplicity of blanks of fibre texture and plastic material, wherein the individual blanks are added step by step, and in each case are consolidated, i.e. cured or transformed to the solidified state during or in the context of being added.

The term “consolidation” and corresponding terms having the same radical are to be understood in particular in a technical-physical and/or technical-chemical context within which consolidation is meant to be in particular hardening, stabilization, stiffening and/or solidification. The terms “curing” or “crosslinking” used at times in the context of fibre-reinforced plastics, for example for duroplastic materials, and “solidification”, for example for thermoplastic materials, are within the meaning of the term “consolidation” as described above.

The term “in situ” used in the context of the invention is to mean in particular that consolidation takes placed directly subsequent to the positioning of the blank at the target location of the structure and is thus connected in particular with a part-structure which may optionally already exist. The spatial structure grows as each blank is added, until the spatial structure is present in an already consolidated state once the last blank is finally added. The method proposed herein makes it possible for blanks to be deposited in a targeted and oriented manner, for example on a negative mould or a positive mould, or in a tool, so as to obtain a spatial composite structure which is configured, in particular reinforced, to suit the operational demands with complete consolidation of the composite taking place directly when the blanks are deposited.

It has been demonstrated in particular that by way of the proposed method a separate downstream curing and consolidation step after the last fibre-texture blank has been added can be dispensed with, since the fibre-texture blanks are in each case already separately consolidated in situ, in particular at or during depositing. Besides, it has been realized in the context of the invention that on account of the successive construction of the structure, in particular of the in-situ consolidation, a comparatively wide variety of shapes can be attained from a multiplicity of blanks. It has also been found that comparable structures can be manufactured more cost-effectively using the proposed method than with the known methods. Furthermore, advantages with respect to the general construction of the structure are derived, in particular because the material thickness, fibre orientation, overlapping of blanks, etc. can be selected so as to be specific in a localized manner and can be readily implemented and varied by way of the spatial structure. In particular, spatial structures which are fibre-reinforced in a localized manner to suit operational demands, in particular structural components, components, supporting structures, spatial structures, in particular spatial structures having planar and/or curved faces may be manufactured. In the case of the proposed method, a comparatively high quality of laminate can furthermore be attained without further downstream process steps.

In particular, in the case of the proposed method, manual depositing processes for the fibre-texture blanks can be largely if not entirely avoided, which favours economical and reproducible manufacturing of fibre-reinforced structural components. In the case of the method being carried out in a suitable manner and when corresponding machines and devices are implemented, it is even possible for corresponding spatial structures to be manufactured in a fully automated manner, corresponding to industrial production. In contrast to methods which are already known, the method according to the invention offers a wide latitude for the fibre orientations of the blanks that can be realized and implemented in relation to the complete structure. In contrast to conventional methods, material may be saved in certain circumstances in this manner. The latter may lead in particular to a reduction in component weight and/or reduced production costs.

It is provided in design embodiments of the method that a fibre-texture blank is attached to an already existing and cured part-structure, in that the fibre-texture blank is arranged or deposited or placed, respectively, so as to overlap in part, in particular on the peripheries, with directly adjoining, already cured or consolidated, respectively, fibre-texture plastic blanks, and the plastic material which forms the matrix for the fibre-texture blank is consolidated in situ at the depository. By way of the degree of overlap, optionally while considering the respective alignment and orientation of the fibres of the fibre texture, the degree of reinforcement can be adapted in particular to the strength/rigidity required in each case. In other words, this means in particular that, depending on demand, local increases in thickness of the laminate for adjusting the strength/rigidity required in each case are possible. Moreover, the method also makes it possible for at least part of the fibre-texture blanks and/or at least part of the edges of the fibre-texture blanks to be arranged so as to have mutually abutting edges, i.e. in a butt joint, in particular having edges which mutually abut in a blunt manner, with or in relation to directly adjacent fibre-texture blanks. As already mentioned, there is furthermore the possibility of arranging the fibre-texture blanks in a staggered manner in relation to one another, wherein in this case a gap which initially exists between adjacent fibre-texture blanks can be patched by plastic material of the matrix during consolidation.

It is provided in design embodiments of the invention that the fibre-texture blanks display fibres having at least one preferred fibre direction, and the fibre-texture blanks are arranged having an in each case predefined local preferred direction for the fibres. On account of an arrangement corresponding to a local preferred direction of the fibre-texture blanks and/or fibres, the local strength/rigidity of the spatial structure required in each case can be attained or adjusted, respectively. In particular, the possibility for varying the local fibre orientation in a comparatively simple manner is enabled by the proposed method according to the invention, as per which the spatial structure is successively constructed from fibre-texture blanks, having locally in each case a consolidation which takes place in situ.

In further design embodiments of the method according to the invention, during manufacturing of the structure at least one fibre-texture blank can be impregnated in situ, for example during application, attachment and/or transfer to the respective target position, with the plastic material which forms the matrix, and/or during manufacturing of the structure at least one fibre-texture blank can be used as a semi-finished product which has already been soaked with the plastic material of the matrix and which is then taken in an automated manner to the respective target position. Fibre textures or fibre fabrics which have already been pre-soaked or preimpregnated, respectively, may be used in particular as a semi-finished product, and preferably so-called organometallic sheets, pre-consolidated fibre-plastic sheets having a thermoplastic matrix, thermoplastic fibre tapes, foils/films may be considered. Nevertheless, processing of preimpregnated fibrous semi-finished products having a duroplastic matrix (synthetic resin, such as, for example, epoxy resin, polyester resin or vinyl ester resin), so-called prepregs, which are in particular usual in the aerospace sector is also readily possible using the method described.

As can be deduced from the aforementioned in particular, the advantage of the proposed method according to the invention lies also in a comparatively high flexibility in terms of the raw material and in the provision of the respective raw materials and semi-finished products. As demonstrated, the method is not limited to a single type of raw materials, preliminary materials and semi-finished products, but may be carried out in a flexible manner in various preliminary conditions and situations.

As per further design embodiments of the method, the plastic material of the matrix, if and when required, may be melted or liquefied by a heating unit, and the fibre-texture blank which is impregnated with the plastic material, in the melted or liquefied state, thereafter may be taken in an automated manner, in particular using a robotic arm, from the heating unit to the target position of the structure and consolidated in situ. Here, for melting/liquefying the plastic material, heating units such as, for example, heating ovens, heating belts, etc., on which the plastic fibre-texture blanks which are to be processed to form the spatial structure are provided, may be used for example. Corresponding heating units here in particular may be configured so as to be independent and/or remote from the conveying units, such as, for example, robotic arms, which are provided for taking the fibre-texture blanks to the target position.

In further design embodiments it is possible that the plastic material of the matrix is melted by a heating unit which is integrated in a gripping and positioning head of a conveying unit, in particular a robotic arm, used for positioning the fibre-texture blank at the target position of the spatial structure. In the case of such design embodiments, the respective plastic fibre-texture blanks may be melted or liquefied, respectively, during transfer from the initial position to the target position on the spatial structure. However, it is also possible that melting or liquefying first takes place at the location of the target position for the respective fibre-texture blank. A potential advantage which may result when using a heating unit which is integrated in the gripper arm, for example, is that the degree of melting or liquefying, respectively, in particular the optimal degree of melting or liquefying, can be adjusted at the target position in a suitable manner by the corresponding operation of the heating unit which is integrated in the gripping and positioning head. It should also be noted that for heating or heating up the fibre-texture blanks also a combination of an external heat source, for example for preheating, and a heating unit which is integrated in the conveying unit used for conveying the fibre-texture blanks to the target position may be used.

As per further design embodiments of the method, the individual fibre-texture blanks are picked up by means of a gripping and positioning head which operates by way of a suction effect and are deposited at the target position, in particular on a moulding tool or a negative or positive mould, respectively. The suction effect here may be preferably generated by a volume flow, in particular a volume flow of air or gas, generated through a membrane. In particular, an elastomeric pad or an elastomeric block, respectively, or a membrane may be present or provided, respectively, on the gripping head, which elastomeric pad or elastomeric block or membrane displays one or more suction ducts or suction openings through which a volume flow can be generated in such a manner that a suction effect caused by the volume flow enables the pick-up of a fibre-texture blank at the gripping head. In particular, a device for generating the volume flow may be present, wherein the device and ducts coupled thereto are configured and adapted in such a manner that on account of the suction effect a retaining force by way of which, for example, in each case one fibre-texture blank can be retained on the gripping head can be generated.

A gripping unit which is configured so as to correspond to the preceding explanations enables particularly gentle gripping or transferring, respectively, of a fibre-texture blank to the target position. Moreover, for example an elastomeric pad or an elastomeric block, respectively, on the gripping and positioning head enable pressing of the fibre-texture blank by the gripping and positioning head which, thanks to the elasticity, is uniform and moreover gentle to the material, during the localized in-situ consolidation. The elastomeric pad or the elastomeric block, respectively, in particular may be configured such that the fibre-texture blank is attracted thereto on account of the suction effect.

As per a variant of the method, at the target location or at the target position, respectively, the fibre-texture blanks which are impregnated with the plastic material may be cured or consolidated, respectively, under impingement with pressure. In a preferred manner, the pressure required in each case is applied through the gripping head or positioning head, respectively. As already mentioned, the pressure required for impinging the fibre-texture blank with pressure may be applied in particular to the respective fibre-texture blank by means of the elastomeric pad or the elastomeric block, respectively. As already described, elastomeric materials used as pressure-impinging elements enable a comparatively uniform impingement with pressure, in particular across the surface of the fibre-texture structure. Moreover, in comparison to metallic surfaces or blocks, for example, damage to the fibre texture on account of the elastic material can be largely precluded or avoided.

As per a further variant of the method, the suction ducts of the elastomeric pad or the elastomeric block, respectively, can be configured in such a manner that the former, when pressed against the fibre-texture blank, are compressed in such a manner that a substantially uniform surface pressure but at least a surface pressure which is sufficient for attaining the in each case desired degree of consolidation can be attained. This is to mean, in particular, that the suction ducts are preferably adapted such that during impingement of the fibre-texture blank with pressure the former are deformed such that at least the surface pressure required in each case is attained.

In a further variant, during the impingement of the fibre-texture blank with pressure in order to cure or consolidate, respectively, the plastic material, the membrane, for example the elastomeric pad or the elastomeric block, on the side which faces away from the fibre-texture blank, is impinged with positive pressure, such that the membrane is pressed against the fibre-texture blank with a predefined force and, in particular, a pressure which favours consolidation is generated.

The use of a pressure-impinged membrane for impinging the fibre-texture blank with pressure is advantageous in particular in the manufacture of curved faces, since, in particular, any potential deviations of the gripping and positioning head from the optimal consolidation position can be compensated for. In particular, even in the case of a not quite optimal positioning of the gripping and positioning head in relation to the fibre-texture blank, sufficient surface pressure, in particular surface pressure which is adequate in a localized manner, can be attained.

Besides or additionally to the force generated by positive pressure, other pressure-generating measures may be taken. This means in particular that a plurality of different measures may be implemented for generating pressure. For example, the gripping and positioning head may be pressed onto the fibre-texture blank by the robotic arm, for example, such that a pressure which is suitable for consolidation, but at least a proportion of pressure which is suitable in each case, is generated.

In variants, it is possible that for generating the pressure through the gripping head onto the fibre-texture blank, the gripping head is at least in part magnetic or magnetisable in such a manner, and a magnetic field is generated in such a manner that, on account of the effect of the magnetic field, a force which acts between the gripping head and the depository tool or the negative mould or positive mould and which presses the gripping head onto the depository tool or the negative mould or positive mould and thus facilitates or enables, respectively, the impingement of the fibre-texture blank with pressure is generated. To this end, a magnetic, in particular a paramagnetic, in particular a ferromagnetic metallic moulding tool, or a magnetic, in particular a paramagnetic, in particular a ferromagnetic metallic negative mould or positive mould may be used for example, and the gripping and positioning head may be equipped in such a manner with a solenoid that upon activation of the solenoid at the target position of the moulding tool or the negative mould or positive mould, respectively, a magnetic force acting between the moulding tool or the negative mould or positive mould, respectively, and the gripping head is generated, on account of which the gripping and positioning head and the moulding tool or the negative mould or positive mould, respectively, are pressed together, such that the plastic fibre-texture blank lying therebetween is impinged with a pressure which at least contributes towards consolidation.

Generating of pressure based on magnetic fields may be implemented either in that the magnetically generated pressure is sufficient for consolidation, or in that the magnetically generated pressure acts only in a supporting manner to other pressure sources. In particular, the supporting effect of magnetic fields is suited to comparatively small robotic arms, etc., which per se can generate and apply comparatively less pressure. In other words, in the case of the generation of supporting, in particular magnetic pressure, it is possible for the robotic arms which are used in each case to be executed in a smaller and lighter manner, since on account of the involvement of the supporting measure, in particular the magnetic coupling, the robotic arms themselves have to produce less force.

In design embodiments of the method according to the invention, said method may comprise the following steps:
providing a fibre-texture blank and a plastic material which configures the matrix;
melting or liquefying, respectively, the plastic material, in particular by way of active heating;
transferring the fibre-texture blank in an automated manner to the target location or the target position, respectively, of the spatial structure;
consolidating the fibre-texture blank by way of:
   exerting a compressive force on the fibre-texture blank or the composite-material portion, respectively, which is impregnated with the plastic material, and optionally heating the composite-material portion for melting, liquefying or curing, in particular based on chemical reactions, the impregnated fibre-texture blank, and optionally
   cooling, in particular actively cooling, the composite-material portion of the spatial structure, preferably while maintaining a compressive force until the consolidation process is terminated.

The individual steps may be carried out in particular so as to correspond to the variants and/or design embodiments described above.

In variants of the method it may be provided that heating takes place by way of impingement by infrared radiation, by induction, and/or by resistance heating. A heating unit here may be integrated in or on a gripping or positioning head, as already mentioned, or be integrated externally in the region of material provision.

In variants it is furthermore possible that the fibre-texture blank, for transfer thereof to the target location or to the target position, respectively, of the spatial structure takes place by way of involvement of adhesion forces, vacuum or suction forces, respectively, and/or by clamping forces. In particular, a gripping and positioning head provided with suction ducts may used here, as already described above.

Furthermore, in the case of variants of the method it is possible that consolidation takes place by way of involvement of a membrane, an elastomeric layer, an elastomeric block, and/or a multiple die. Advantages are derived in particular therefrom that a surface pressure which is substantially identical or at least sufficient or required in a localized manner for the necessary degree of consolidation is obtained across the entire surface of the fibre-texture blank. Moreover, elastomeric materials have the advantage that they can readily adapt to any potential curvatures.

In further variants, cooling may take place by way of passive cooling, active cooling, in particular by way of impingement with a fluid, in particular air or a liquid.

In even further variants, exerting the compressive force may take place at least by way of involvement of a robotic arm, a pressure force generated by positive pressure, and/or by way of a force generated by a magnetic field.

The present invention is further directed to a device for the automated manufacturing of a spatial structure from fibre-reinforced plastic. The device is configured for manufacturing the structure in an automated manner by successively joining a multiplicity of fibre-texture blanks and in each case selectively carrying out consolidation in situ of the fibre-texture blanks which are impregnated with a plastic material. The proposed device comprises:
a unit for receiving and positioning a fibre-texture blank on a target position of the structure, in particular comprising a robotic arm and the like;
a unit, in particular an oven, a heating plate or a heating pad, for heating the plastic material, in particular the fibre-texture blank, with the associated plastic material, for generating a composite material which is composed of the melted or liquefied, respectively, plastic material and the fibre-texture blank;
a unit for the in-situ consolidation of the composite material at the target location or at the target position, respectively, of the spatial structure in particular comprising:
   a unit for selectively impinging the composite material at the target position with a compressive force or pressure force for locally, in particular successively in situ, consolidating the composite material at the target location or at the target position, respectively, and
   optionally a unit for, in particular actively and/or passively, cooling the composite material at the target location or at the target position, respectively, for example by a gas flow and/or a liquid flow; and

wherein the device is configured for manufacturing the structure as per the method according to the invention, or variant or design embodiment, respectively, thereof.

Advantages and advantageous effects of the device are derived in particular from the advantages of the respective method-related features. In particular, the device makes possible the manufacturing of spatial structures from fibre-reinforced plastic materials. Furthermore, the device makes possible a comparatively cost-effective manufacturing of corresponding spatial structures. Moreover, the proposed device makes possible the automated, in the case of suitable programming even fully automated, manufacturing of spatial structures from fibre-reinforced plastic materials, in particular while considering strength or rigidity requirements, respectively, which are required in each case in a localized manner. Using the proposed device, it is in particular possible to implement and adjust in a comparatively simple manner structural parameters, such as, for example, fibre orientation, number of laminate layers, degree of overlap between directly adjacent fibre-texture blanks, etc., according to the requirements in each case.

### BRIEF DESCRIPTION OF THE DRAWINGS

Exemplary design embodiments of the invention are described in the following in conjunction with the appended figures, by means of specific exemplary embodiments. In the drawings:

FIG. 1 shows a first spatial structure which has been partially manufactured as per the method according to the invention from fibre-texture blanks;

FIG. 2 shows a partially manufactured second spatial structure from fibre-texture blanks;

FIG. 3 shows an example pertaining to the automated manufacturing of a component from fibre-crosslay blanks;

FIG. 4 shows an installation and a potential method procedure for the automated manufacturing of a structural component from fibre-crosslay blanks;

FIG. 5 shows a first detail of the installation as per FIG. 4;

FIG. 6 shows a second detail of the installation as per FIG. 4; and

FIG. 7 shows a detail of a depositing and gripping head of the installation as per FIG. 4.

### DETAILED DESCRIPTION OF THE INVENTION

Unless anything to the contrary is derived from the following description, identical elements, or elements having identical functions, are identified with identical reference signs in the figures.

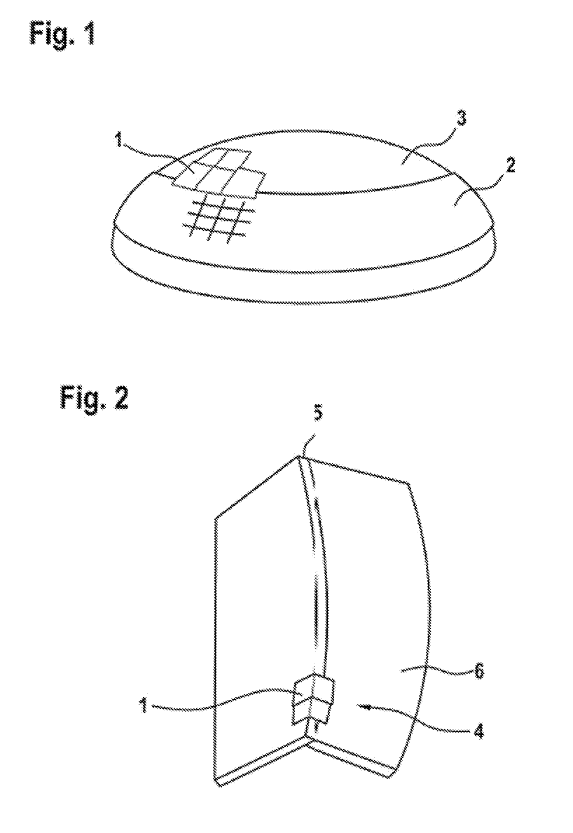

FIG. 1 shows a first spatial structure 2 from fibre-texture blanks 1, which has been already partially completed as per the method according to the invention. Corresponding to the method proposed herein, the spatial structure 2, which here in the completed state in an exemplary manner is a shell-type structural component which is curved in a dome-like manner, is successively constructed from a multiplicity of fibre-texture blanks 1.

In the present example, the individual fibre-texture blanks 1, at their respective target position, are laid successively onto a negative mould 3, wherein a plastic material which forms a matrix for the respective fibre-texture blank 1 is consolidated, i.e. treated in such a manner that the plastic material is cured or solidified, respectively, directly after positioning, that is to say in situ at the target position. The fibre-texture blank 1 may be a so-called prepreg, for example. However, other variants, such as those already described above, may also be considered.

As is evident from some fibre-texture blanks 1 which are explicitly illustrated in FIG. 1, in the example of FIG. 1 said fibre-texture blanks 1 are deposited or arranged, respectively, so as to partially overlap one another. More specifically, each of the fibre-texture blanks 1 on the periphery is arranged so as to overlap with the periphery of directly adjacent fibre-texture blanks 1. A partially overlapping arrangement of the fibre-texture blanks may be chosen or may have been chosen, respectively, in particular with respect to the strength, rigidity and the locally required number of fibre-texture layers required in each case.

The successive construction having an in-situ consolidation of the fibre-texture blanks 1 at the target location or depository, respectively, makes possible comparatively simple manufacturing of a multiplicity of different structures having in each case strength and rigidity properties which are adapted, in particular in a localized manner.

FIG. 2 shows a partially manufactured second spatial structure 4 from fibre-texture blanks 1. In the example of FIG. 2, only two of the fibre-texture blanks 1 are shown. For the purpose of reinforcing the edge or for connecting two individual components placed beside one another, the fibre-texture blanks 1 of the second spatial structure are arranged on an edge 5 of a component portion of a further structural component 6. The second spatial structure 4 which in the completed state is configured as an edge reinforcement or as a component connector, respectively, is constructed from individual fibre-texture blanks 1 which are successively adjoined. Corresponding to FIG. 1, the fibre-texture blanks 1 are arranged having the overlap which is required in a localized manner in each case and the in each case required fibre orientation and positioned on the further structural component 6 and consolidated in situ, in particular directly after positioning at the target location of the further structural component 6.

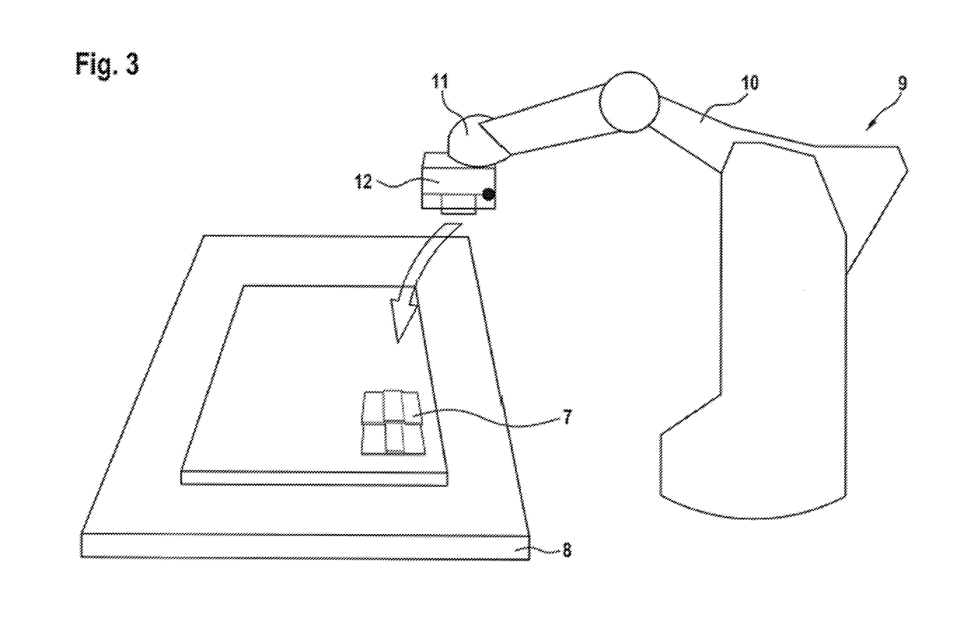

FIG. 3 shows an example for the automated manufacturing of a component 7 from fibre-crosslay blanks 1, which in the present case is configured so as to be planar. On a base 8, in particular a depository tool, individual fibre-texture blanks 1 are deposited at the respective target position by a robot 9, more specifically by a processing head 11 which is attached to a robotic arm 10, and consolidated in situ. The processing head 11 is configured in such a manner that the fibre-texture blanks 1 can be deposited and consolidated on the base 8 so as to correspond to the fibre orientation assigned in each case and, optionally, to the overlap required in each case.

In order to handle the fibre-texture blanks 1, the processing head 11 may display a gripping unit, in particular a suction gripper 12. Furthermore, the processing head 11 may be configured or equipped, respectively, such that the fibre-texture blank 1 which is in each case deposited can be consolidated directly after depositing by the processing head 11 itself. For example, the processing head 11 may display a heating unit, a cooling unit, and/or other units by way of which a degree of consolidation which is required in each case, in particularly required in a localized manner, can be attained.

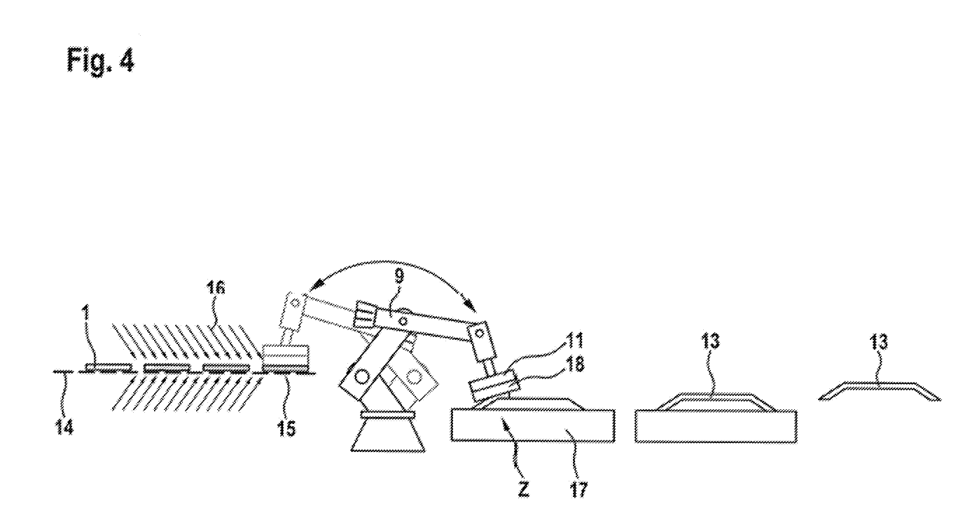

FIG. 4 shows an installation and, connected therewith, a potential method procedure for the automated manufacturing of a structural component 13 from fibre-texture blanks 1.

In the present example, the fibre-texture blanks 1 are supplied to a receiving position 15 by a conveyor or transport belt 14 or a conveying unit. A heating unit 16, by way of which a consolidatable plastic with which the fibre-texture blanks 1 have been impregnated or soaked can be melted or liquefied, thus forming a preliminary step for a final consolidation of the plastic fibre-texture blanks 1, is arranged upstream of the receiving position 15.

The melted or liquefied, respectively, fibre-texture blanks 1 are received at the receiving position 15 by means of a suction gripping unit of the processing head 11 and, by means of the robot 9, deposited at the target position 16 of the negative mould 3, in the present example a depository tool 17, and consolidated in situ. Following the successive placing and consolidation of all fibre-texture blanks 1 on the depository tool 17, the completed structural component 13 can be removed from the depository tool 17 and supplied to potential further processing stations.

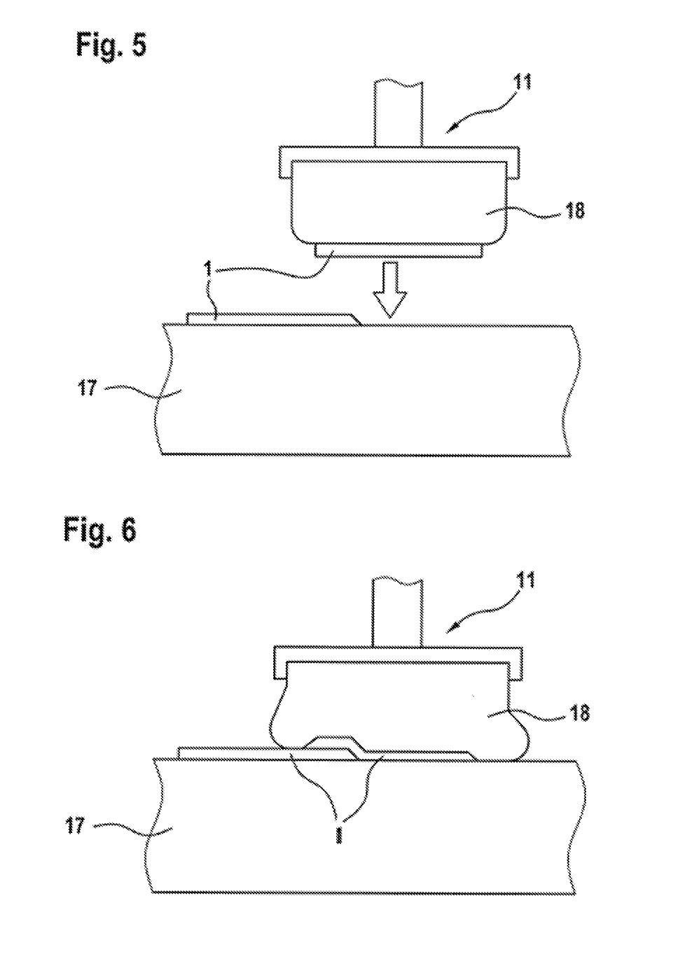

FIG. 5 shows a first detail of the installation as per FIG. 4. Specifically, FIG. 5 shows a processing head 11 which is in particular configured as a gripping and positioning head. In the present example, the processing head 11 comprises an elastomeric block 18 from an elastomeric material. The fibre-texture blanks 1 are received on an exposed side of the elastomeric block 18, taken to the target position 16 and consolidated. For consolidation, the melted or liquefied, respectively, plastic fibre-texture blank 1 is pressed by the processing head 11 against or onto the depository tool 17, respectively, using a compressive force which is required and sufficient for attaining the respective degree of consolidation.

The procedure of pressing the plastic fibre-texture blank 1 onto the depository tool 17 can be identified more clearly in the context of FIG. 6, which shows a second detail of the installation as per FIG. 4. By means of the elastomeric block 18 which is of an elastic shape, the fibre-texture blank 1 is pressed onto or against the depository tool 17, whereby on account of the elasticity of the elastomeric block 18 the pressure surface of said elastomeric block 18 which bears on the fibre-texture blank 1 adapts to the respective local surface conditions. In this manner, the fibre-texture blank 1 can be impinged with the force required in each case across its entire surface. It has been demonstrated that use of an elastomeric material for the impingement with pressure during the consolidation of the fibre-texture blank 1 is advantageous for optimal consolidation. In the case of non-flexible elements for the impingement with pressure it may occur under certain circumstances that individual spots of a fibre-texture blank 1, for example in the region of the overlap with adjacent blanks, are not cured according to the degree of consolidation required in each case.

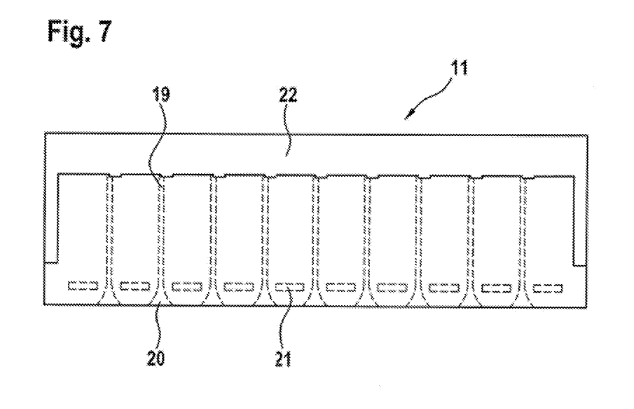

FIG. 7 shows a detail of a depositing and gripping head of the installation as per FIG. 4. In order to configure the elastomeric block 18 as a gripping head 11 configured as a suction head, said gripping head 11 may display suction ducts 19 having suction openings 20, on or by way of which the fibre-texture blanks 1 can be retained by a retaining force which is generated by a suction effect. The suction effect may be generated by way of a volume flow of air through the suction ducts 19, for example. By interrupting the volume flow of air, the processing head 11 can be removed from the fibre-texture blank 1 without force, i.e. without a force action on the fibre-texture blank 1. The suction ducts 19 which in FIG. 7 are merely illustrated in a schematic manner are preferably configured in such a manner that, when performing the pressing operation, i.e. when impinging the fibre-texture blank 1 with a compressive force, they do not have any substantial effect on the quality of consolidation.

The elastomeric block of FIG. 7 furthermore displays cooling ducts 21 which are optional per se and through which a cooling medium, for example air, a gas, water, or any other liquid, can be directed. By way of provision of the cooling ducts 21 it is possible for the fibre-texture blanks 1 which are positioned at the target position to be cooled in an active or targeted manner, respectively, which may be of advantage in order to rapidly attain the respective degree of consolidation for example.

Additionally, it may be provided that the intermediate space which is located between a holding shell 22 for the elastomeric block 18 and the elastomeric block 18 can be impinged with pressure, such that in the case of a positionally fixed processing head 11 and an arrested robotic arm 10 an optional additional force which acts in the direction of the fibre-texture blank 1 can be generated. The possibility of the optional additional generation of a pressure for impingement of the fibre-texture blank 1 makes possible a flexible adaptation of the effectively acting pressure and compressive forces to local requirements of consolidation or curing, respectively, in particular in the case of an unchanged manner of operation and movement of the robotic or gripping and positioning arm.

A further or alternative possibility for generating an optional additional compressive force for the impingement of the fibre-texture blank 1 is the generation of a magnetic field, by way of which the processing head 11, in particular the elastomeric block 18, can be impinged with a force in the direction of the depository tool 17, such that on account thereof the fibre-texture blank 1 which is located between the depository tool 17 and the processing head 11 is impinged with a compressive force, in particular for consolidation.

In order to generate the magnetic field, the processing head 11 may display, for example, a solenoid and similar in such a manner that when the solenoid is activated a magnetic field is generated, by way of which the processing head 11 is pulled in the direction of the depository tool 17 when, for example, a paramagnetic, in particular a ferromagnetic depository tool 17 or a paramagnetic, in particular a ferromagnetic depository face is used, and the fibre-texture blank thus can be impinged with an optional additional compressive force. An advantage may be seen here in particular in that the compressive force can be generated in a complementary manner and/or switched on in a flexible manner in addition to that force generated by way of the processing head 11 per se and/or by way of the pressure impingement of the elastomeric block 18 or a corresponding elastomeric film, for example.

Overall, it is derived that the proposed method according to the invention and the corresponding device achieve the underlying object.

### LIST OF REFERENCE SIGNS

1 Fibre-texture blank
2 First spatial structure
3 Negative mould
4 Second spatial structure
5 Edge
6 Further structural component
7 Component
8 Base
9 Robot
10 Robotic arm
11 Processing head
12 Suction gripper
13 Structural component
14 Conveyor belt
15 Receiving position
16 Heating unit
17 Depository tool
18 Elastomeric block
19 Suction duct
20 Suction opening
21 Cooling duct
22 Holding shell

1. A method for the automated manufacturing of a spatial structure from fibre-reinforced plastic, wherein the spatial structure is constructed successively and in an automated manner from a multiplicity of individual fibre-texture blanks, in that the individual fibre-texture blanks are deposited successively, in particular so as to be adjoining, and in that a plastic material which forms a matrix for the in each case deposited fibre-composite blank is consolidated in situ at the depository.

2. The method according to claim 1, wherein a fibre-texture blank is attached to an already existing and cured part-structure, in that the fibre-texture blank is arranged so as to overlap in part, in particular on the peripheries, and/or by way of edges which abut at least in portions and/or edges which are arranged so as to be staggered at least in portions in relation to directly adjoining, already cured fibre-texture plastic blanks, and wherein the plastic material which forms the matrix for the attached fibre-texture blank is locally consolidated in situ.

3. The method according to claim 1, wherein the fibre-texture blanks display fibres having at least one preferred fibre direction, and the fibre-texture blanks are arranged having an in each case predefined local preferred direction for the fibres.

4. The method according to claim 1, wherein during manufacturing of the spatial structure at least one fibre-texture blank is impregnated in situ with the plastic material which forms the matrix and/or wherein during manufacturing of the spatial structure at least one fibre-texture blank is used as a semi-finished product which has already been soaked with the plastic material of the matrix.

5. The method according to claim 1, wherein the plastic material of the matrix is melted or liquefied by a heating unit, and the fibre-texture blank which is impregnated with the plastic material, in the melted or liquefied state, is taken in an automated manner, in particular using a robotic arm, from the heating unit to the target position of the spatial structure and consolidated in situ.

6. The method according to claim 1, wherein the plastic material of the matrix is melted or liquefied by a heating unit which is integrated in a gripping and positioning head of a conveying unit, in particular a robotic arm, used for positioning the fibre-texture blank at the target position of the spatial structure.

7. The method according to claim 1, wherein the individual fibre-texture blanks are picked up by means of a gripping head which operates by way of a suction effect and are deposited at the target position, in particular on a moulding tool or a negative or positive mould, respectively, wherein the suction effect is caused preferably by a volume flow generated through a membrane, in particular by a volume flow generated through suction ducts of an elastomeric pad or an elastomeric block, respectively, of the gripping head.

8. The method according to claims 6, wherein at the target location the fibre-texture blanks (1) which are impregnated with the plastic material are cured under impingement with pressure, wherein the pressure is applied through the gripping head, in particular through the elastomeric pad or the elastomeric block, respectively, onto the respective fibre-texture blank.

9. The method according to claim 8, wherein the suction ducts of the elastomeric pad or the elastomeric block, respectively, are configured in such a manner that the former, when pressed against the fibre-texture blank, are compressed in such a manner that a surface pressure which is required for attaining the respective degree of consolidation can be attained.

10. The method according to claim 8, wherein during the impingement of the fibre-texture blank with pressure in order to cure the plastic material, the membrane on the side which faces away from the fibre-texture blank is impinged with positive pressure, such that the membrane is pressed against the fibre-texture blank with a predefined force.

11. The method according to claim 8, wherein for generating the pressure through the gripping head onto the fibre-texture blank, the gripping head is at least in part magnetic in such a manner and a magnetic field is generated in such a manner that, on account of the effect of the magnetic field, a force which acts on the gripping head and which presses the gripping head onto the fibre-texture blank is generated.

12. A method according to claim 1, comprising the following steps:
providing a fibre-texture blank and a plastic material which configures the matrix;
melting or liquefying, respectively, the plastic material, in particular by way of active heating;
transferring the fibre-texture blank in an automated manner to the target location of the spatial structure;
consolidating the fibre-texture blank by way of:
exerting a compressive force on the fibre-texture blank or the composite-material portion, respectively, which is impregnated with the plastic material, and optionally heating the composite-material portion for melting, liquefying or curing, in particular based on chemical reactions, the impregnated fibre-texture blank, and optionally
cooling, in particular actively cooling, the composite-material portion of the spatial structure, preferably while maintaining a compressive force until the consolidation process is terminated.

13. The method according to claim 12, wherein heating takes place by way of impingement by infrared radiation, by induction, and/or by resistance heating; and/or
the fibre-texture blank, for transfer thereof to the target location, takes place by way of involvement of adhesion forces, vacuum or suction forces, respectively, and/or by clamping forces; and/or
consolidating takes place by way of involvement of a membrane, an elastomeric layer, an elastomeric block, and/or a multiple die, and/or
cooling takes place by way of passive cooling, impingement with a fluid, in particular air or a liquid; and/or
exerting the compressive force takes place at least by way of involvement of a robotic arm, a pressure force generated by negative pressure, and/or by way of a force generated by a magnetic field.

14. A device for the automated manufacturing of a spatial structure from fibre-reinforced plastic, wherein the device is configured for manufacturing the spatial structure in an automated manner by successively joining a multiplicity of fibre-texture blanks and in each case selectively curing the fibre-texture blanks which are impregnated with a plastic material, wherein the device comprises:
a unit for receiving and positioning a fibre-texture blank,
a unit for heating the plastic material, in particular the fibre-texture blank, with the associated plastic material, for generating a composite material which is composed of the melted or liquefied, respectively, plastic material and the fibre-texture blank,
a unit for the in-situ consolidation of the composite material at the target position, in particular comprising:
a unit for selectively impinging the composite material with a compressive force for locally curing the composite material at the target position, and
optionally a unit for cooling the composite material at the target position,
wherein the device is configured for manufacturing the spatial structure according to a method according to claim 1.
